(19) United States
(12) Patent Application Publication
(10) Pub. No.: US 2010/0235886 A1
(43) Pub. Date: Sep. 16, 2010

(54) AUTOMATED RELATIONSHIP MANAGEMENT FOR ELECTRONIC SOCIAL NETWORKS

(75) Inventors: Samuel Muller, Zurich (CH); Dieter M. Sommer, Zurich (CH)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/404,736

(22) Filed: Mar. 16, 2009

(51) Int. Cl. G06Q 99/00; H04L 9/32

(52) U.S. Cl. 726/4; 705/319

(57) ABSTRACT

A computer-implemented method of automatically managing relationships between a plurality of users within an electronic social network. The method includes monitoring interactions between the plurality of users in relationships within the electronic social network over time, and obtaining interaction information associated with the monitored interactions, and automatically updating and managing access privileges of users based on the obtained interaction information, to access profile information of respective users. The method ensures automated, adequate and dynamically changing representation of relationships in an ESN system, thereby greatly increasing the value of the ESN system to the user and ways to pro-actively maintain and improve existing relationships or prevent them from decaying.

### BACKGROUND

The present invention relates to electronic social networks (ESNs), and more specifically, to automated relationship management for electronic social networks.

Electronic social networks support people in establishing and electronically representing relationships with friends, colleagues, etc. While relationships with other ESN users can be easily established, conventional electronic social networks provide very limited support for managing the changing nature and quality of an established relationship over time. For example, in a conventional electronic social network, the user manually tracks all his/her relationships with other ESN users and continually assesses whether the quality of the ESN relationships appropriately reflects the quality of the actual relationships. These conventional electronic social networks do not provide mechanisms for the users to manage their ESN relationships in a realistic and time-efficient manner. Therefore, the ESN relationship often does not appropriately reflect the actual relationship between the ESN users, thus the value of the ESN to the user is often less than it could be with proper support of relationship management through the ESN.

### SUMMARY

The present invention provides an electronic social network which enables automated management of relationships within the electronic social network.

According to one embodiment of the present invention, a computer-implemented method of automatically managing relationships between a plurality of users within an electronic social network is provided. The method includes monitoring interactions between the plurality of users in relationships within the electronic social network over time, and obtaining interaction information associated with the monitored interactions, and automatically updating and managing access privileges of users based on the obtained interaction information, to access profile information of respective users.

According to another embodiment of the present invention, a computer program product comprising a computer useable medium including a computer readable program, wherein the computer readable program when executed on a computer causes the computer to implement a method of automatically managing relationships between a plurality of users within an electronic social network is provided. The method includes monitoring interactions between the plurality of users in relationships within the electronic social network over time, and obtaining interaction information associated with the monitored interactions, and automatically updating and managing access privileges of users based on the obtained interaction information, to access profile information of respective users.

According to another embodiment of the present invention, an electronic social network system is provided. The electronic social network system includes a plurality of user interfaces, a network, and a server in communication with the plurality of user interfaces via the network. The server is operative to monitor interactions between the plurality of users in relationships within the electronic social network system over time, and obtain interaction information associated with the monitored interactions, and automatically update and manage access privileges of users based on the obtained interaction information, to access profile information of respective users.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram illustrating an electronic social network system that can be implemented within embodiments of the present invention.

FIG. 2 is a flowchart illustrating a method of automatically managing relationships within an electronic social network that can be implemented within embodiments of the present invention.

### DETAILED DESCRIPTION

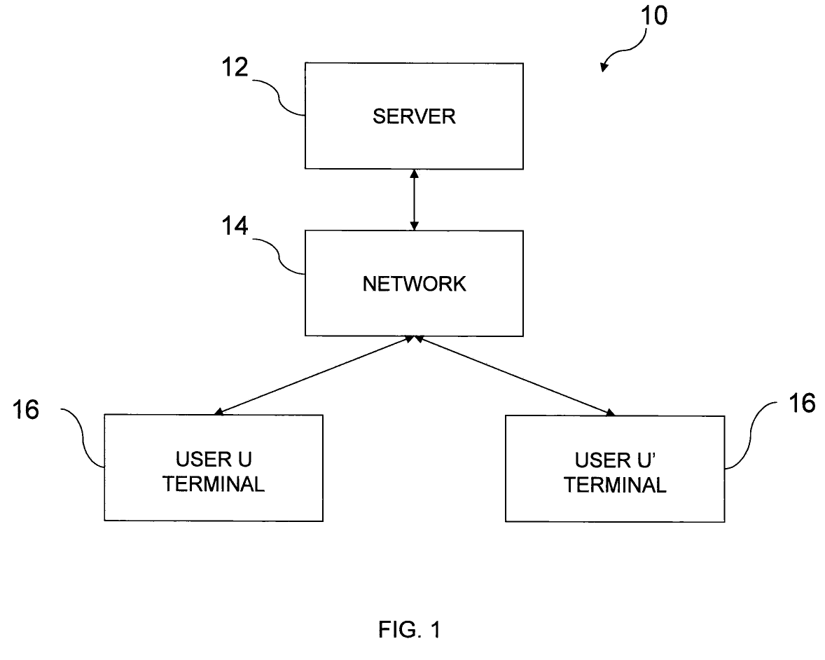

With reference now to FIG. 1, there is an electronic social network that can be implemented within an embodiment of the present invention. As shown in FIG. 1, an electronic social network (ESN) system 10 includes a server 12, a network 14 and user interfaces, for example, a plurality of user terminals 16, user u terminal and user u′ terminal in communication with the server 12 via the network 14. The user terminals 16 may include a personal computer (PC), a personal digital assistant or any other suitable communication device. The network 14 may include, for example, the Internet, an intranet or any other suitable communication medium. The server 12 is shown as a separate processor however the functions of the server 12 may be performed via one of or a combination of the user terminals 16. The server 12 is capable of handling heavy loads including millions of users, for example, technology platforms such as Java 2 Enterprise Edition (J2EE)™ or Microsoft.NET™ may be employed. The server 12 can be implemented by a plurality of connected physical machines. According to an embodiment of the present invention, the server 12 has monitoring and notification capabilities. However, according to alternative embodiments, the ESN system 10 may include a monitoring unit and a notification unit, separately or combined in communication with the server 12. Each user interface may be a Web-2.0-based interface or a separate client as shown, for example. The present invention is not limited to any particular number of users. Each user has an associated profile and shares specific profile information with selected others in relationships with the users within the ESN system 10.

The embodiments of the present invention allow for automatically managing ESN relationships between users within the ESN system 10. The ESN system 10 performs an automated method for updating and managing relationship information between the users within the ESN system 10.

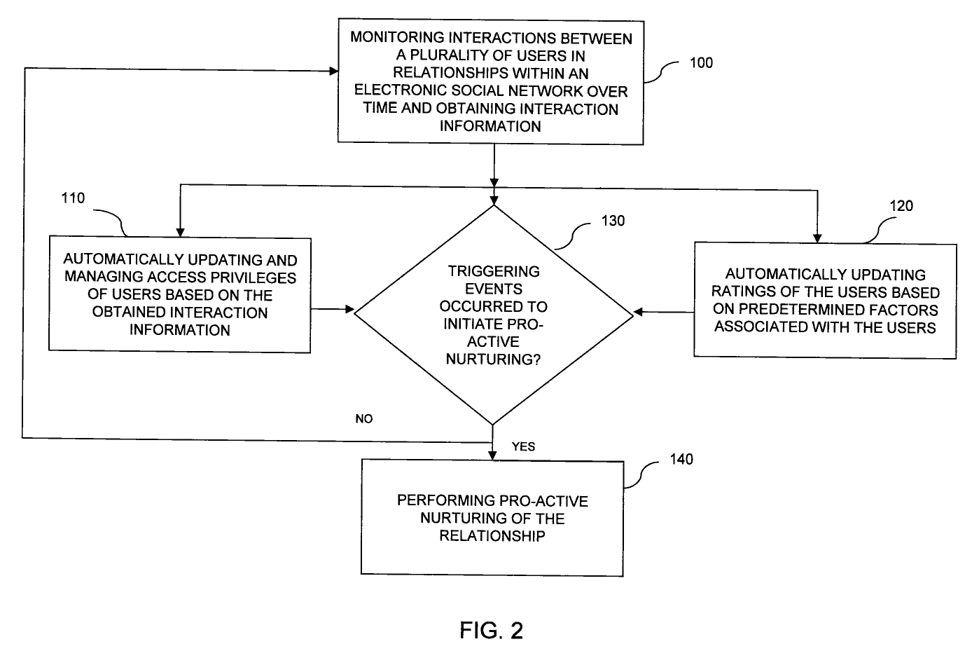

According to embodiments of the present invention, the quality of a relationship between user u and user u′ is characterized based on the accessible profile information shared between the users u and u′. In addition, the quality of the relationship may also be characterized based on ratings of metrics predefined by the user or system, associated with each user as disclosed in application Ser. No. 12/246,632 filed on Oct. 7, 2008, and entitled “ACCESS TO ELECTRONIC SOCIAL NETWORK” by Müller and Sommer, which is incorporated herein by reference in its entirety and made a part hereof (additional details to be discussed further below). According to one embodiment, the server 12 monitors interactions between the plurality of users u and u′ over time and performs a method for automatically managing relationships between a plurality of users within the ESN system 10, as shown in the flowchart in FIG. 2, for example.

FIG. 2 illustrates a method of automatically managing relationships between a plurality of users within the ESN system 10. At operation 100, interactions between the plurality of users are monitored and interaction information associated with the monitored interactions is obtained via either the server or a dedicated monitoring unit in communication with the server, for example. According to an embodiment of the present invention, the monitoring may be performed by a notification via a communication system of the users or by the communication system being integrated into the electronic social network. For example, if the communication system is a mobile phone, it may run a software application which notifies the electronic social network of all calls made by the user. In another example, an email client may provide information on each email sent or received by the user to the electronic social network. The interaction information is stored in a storage medium within the server or the monitoring unit or processed by the server in real time leading to an update of appropriate variables. According to an embodiment of the present invention, the interaction information includes at least one of the duration of the relationship between the users, communication events and/or content between the users, contextual information, and ratings associated with each user. As time evolves and the ESN users interact both virtually and physically, the quality of their actual relationship typically changes. For example, if two business contacts mutually engage in a series of business projects over time they may become personal friends. The impact on their relationship would be an increased trust level and an unconditional willingness to let each other access their complete profile information. On the other hand, in another example, if two former coworkers who have continued their careers in different directions have very limited interaction, they may trust each other less after some time and therefore, may not want to share the same amount of profile information as they used to share in the past. Therefore, based on the interaction information obtained, the process moves from operation 100 to operation 110, where access privileges of users are automatically updated and managed based on the obtained interaction information, to access profile information (i.e., the amount and type of profile information) of the respective users. That is, the relationship is managed depending upon the “visibility” of profile information associated with each user. According to an embodiment of the present invention, the profile information corresponds to each user and includes at least one of personal information (i.e., attributes) and contact information associated with contacts of the respective user. For example, the profile information may include, name and geographical information along with birthday, job and salary information, and professional and personal contacts of the user. The present invention is not limited hereto and may vary, accordingly.

As mentioned above, according to an embodiment of the present invention, the access privileges of a user may be varied based upon the duration of the relationship between the users such that as the duration of the relationship increases, the amount of access privileges automatically increases. For example, as the duration of the relationship between two users increases, the server 12 automatically reveals more of the user's attributes to the other user in the relationship and vice versa. According to an embodiment, the user may preset settings which include, for example, name and address information, and the user may specify a time period and/or a frequency for which the server may reveal additional attributes within the user's profile information. Alternatively, the system 10 may set default settings or they may be set by a combination of both the user and the system. For example, the user may preset a minimum amount of time to pass before a contact may access additional attributes of the user's profile information.

Further, as mentioned above, the access privileges may also vary based upon an amount of communication between users over time such that as the amount of communication between the users increases, the amount of access privileges automatically increases, and as the amount of communication between the users decreases, the amount of access privileges automatically decreases. For example, if the users have not communicated with one another for a predetermined period of time such as a period of one year, the access privileges granted to the user may be automatically decreased. According to an embodiment, the server senses an amount of communication between the users. The communication between users may include, for example, at least one of email communication, text messaging and telephone communication. Therefore, according to an embodiment of the present invention, the user's telephone system and/or email system, for example, is integrated with the ESN platform. According to an embodiment of the present invention, email communication may be implemented by a plug-in in the mail client or an integration with the email server and text messaging may be implemented using messaging tools such as Skype and MSN Messenger, for example. The present invention is not limited to any particular form of communication between the users, and may vary accordingly. The contextual information may include geographic location information including location proximity between the users. The present invention is not limited hereto, therefore, and any other type of attribute factors may also be taken into consideration.

According to an embodiment of the present invention, accessing of predetermined profile information is determined after a user has been admitted as a contact of a respective user for a predetermined period of time and after a predetermined number of interactions have occurred between the users. For example, if a user u′ has been a contact of user u for approximately six months and during this time period user u′ and user u have had approximately 10 interactions, then predetermined attributes of user u's profile information will become accessible to user u′ and vice versa. The predetermined attributes may be default settings by the system or user settings or a combination of both.

Further, as mentioned above, according to an embodiment of the present invention, the access privileges may be varied based on ratings of the users on various metrics such as trust or confidence. According to one embodiment, the ratings are determined based on how a user is rated among other users in a relationship with the same user within the ESN system. For example, if other users rate the same user as high on the metric of “trust” then the access privileges for that user will be updated such that the system reveals more profile information of a respective user to that user.

Further in FIG. 2, at operation 120 the system automatically manages ratings among the users based on predetermined factors associated with the users. According to an embodiment of the present invention, the predetermined factors may include at least one of communication between users, idle time of the relationship, contextual information, third-party information, and similarity metrics between the users. The communication between users may include for example, email, telephone communication, or instant messaging. According to an embodiment, the contextual information may be geographic context such as location proximity between the users. The third-party information may be items ordered by both the users u and u′ via a third-party website such as amazon.com for example. Further, the similarity metrics such as similar interest, for example, or correlating activities at correlating times, places, etc. as illustrated via the users' respective calendars may also be predetermined factors.

Further, according to an embodiment, ratings of a user by other users may be a factor when automatically updating rating information. For example, if other users rate specified metrics of the same user u′ consistently high, the ratings of the specified metrics rated by user u for user u′ may be increased if they are low, or if other users rate specified metrics for user u′ very low then the ratings of the specified metrics by user u for user u′ may be decreased if they are high. According to an embodiment of the present invention, the ratings are automatically updated at appropriate predetermined time intervals such as once every week or once a month, for example.

Further, any combination of the above-mentioned predetermined factors may be used to initiate automatically updating of rating information corresponding to a user within the ESN system. When (a) predetermined factor(s) mandate(s) a rating update, an appropriate action is triggered to perform the actual adjustments of the ratings such as decreasing or increasing the rating, for example. For example, if the predetermined factor is communication between the users and if it is determined that for at least 4 months there have been 10 communications per month between the users in a relationship within the ESN system and there has not been an update triggered by this predetermined factor for one month, the metric “trust” is updated by 0.1, which means that for every one month, the metric “trust” is updated by 0.1 when conditions on the communication between the users are met. As mentioned above, these metrics may be system-defined, user-defined or a combination of both. By automatically updating of ratings of users over time, the ESN relationships of users are better managed and higher priority is given to active relationships.

According to another embodiment of the present invention, pro-active nurturing is provided to the users within the ESN system. Pro-active nurturing is the pro-active managing and nurturing of established relationships between users within the ESN system. The ESN system suggests to the user to perform activities that may help keep the relationships strong and to provide tools and execute workflows to support the user in carrying out these activities. Pro-active nurturing may be initiated based on a number of triggering events. According to an embodiment of the present invention, the triggering events may be any events dependent on certain variables reaching a specific state where the variables represent all the relevant data for the event for all involved users such as ratings, communication history of the users, location of the users, idle time of the relationship or any contextual information, for example. In FIG. 2, at operation 130, it is determined whether triggering events have occurred to initiate pro-active nurturing. For example, it is determined whether the relationship has been “idle” more than a predetermined threshold meaning no communication has occurred between the involved users and the first user has rated the second user with equal or greater than 7 on the metric “Importance”, or if rating(s) of predefined metric of a contact fall(s) below a predetermined threshold. According to an embodiment of the present invention, the ratings of a single metric may be considered or a combination of metrics rated by the user for the other user may be considered. When it is determined in operation 130, that no triggering events have occurred, the process returns to operation 100 to continue monitoring interactions between the plurality of users. The pro-active nurturing may be triggered at any time, therefore, it may be triggering as a result of the monitoring of the interactions between the users (operation 100), as a result of automatically updating and managing access privileges of the users (operation 110) or after automatically updating ratings of the users (operation 120). When it is determined in operation 130 that triggering events have occurred, the process moves to operation 140 where pro-active nurturing is performed such that the server or a dedicated notification unit in communication with the server, for example, notifies the user regarding these triggering events and presents a proposed action via the user terminal to be performed by the user. That is, a proposed action may include “call” for calling the user where relevant information on the update of the profile of the other user is displayed to the user to help the user refer to relevant information or interest to make the call more effective for both users or “write mail” for writing mail and providing multiple templates for the user to select from, “chat” for initiating a chat with a chat tool connected to the user terminal or over the server, “Bug” for bugging the other user, for example, old friends, or “Delete” for deleting the user as a contact”, or “leave rating” for leaving the rating below the predetermined threshold in case the user does not want to go for an interaction at that time. According to another embodiment, when a user changes geographic locations to be in close proximity to the geographic location of another user, the proposed action may include “Meeting” for requesting a meeting between the users. These proposed actions are presented to the user based on predefined setting as predefined by the user and/or system, for example. That is, the user can predefine a predetermined amount of time before these proposed actions are to be triggered and presented the user. For example, if the users have not interacted in a period of one year, the rating of the metric “trust” is decreased by one and if the rating of the metric “trust” falls below six, then one or more proposed actions are presented to the user. If the user decides to delete the other user as a contact, then the process ends at operation 140. On the other hand, from operation 140 the process returns to operation 100 to repeat the process.

Embodiments of the present invention provide a method and system for automatically managing ESN relationships to ensure automated, adequate and dynamically changing representation of relationships in an ESN system, thereby greatly increasing the value of the ESN system to the user. The present invention also provides ways to pro-actively maintain and improve existing relationships or prevent them from decaying.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method of automatically managing relationships between a plurality of users within an electronic social network, the method comprising:
monitoring interactions between the plurality of users in relationships within the electronic social network over time, and obtaining interaction information associated with the monitored interactions; and
automatically updating and managing access privileges of users based on the obtained interaction information, to access profile information of respective users.

2. The computer-implemented method of claim 1, wherein the interaction information comprises at least one of duration of the relationship between the users and communication between the users.

3. The computer-implemented method of claim 1, wherein the profile information comprises at least one of personal information and contacts associated with each user.

4. The computer-implemented method of claim 1, further comprising: granting access to selected profile information of a user based on preset default setting as determined by the user.

5. The computer-implemented method of claim 1, wherein automatically updating access privileges comprises automatically updating an amount and type of profile information accessible to each user based on the monitored interaction information.

6. The computer-implemented method of claim 2, wherein an amount of access privileges are varied based on the interaction information associated with the users such that as the interaction information increases, the amount of access privileges increases and as the interaction information decreases, the amount of access privileges decrease for a respective user.

7. The computer-implemented method of claim 2, wherein the communication between the users includes at least one of email communication, text messaging and telephone communication.

8. The computer-implemented method of claim 1, further comprising automatically updating ratings on metrics corresponding to the users based on predetermined factors associated with the users wherein the ratings on metrics are determined based on how a user is rated among other users in relationship with the same user within the electronic social network.

9. The computer-implemented method of claim 8, wherein the ratings are automatically updated based on at least one of communication between users, idle time of the relationship, contextual information, third-party information and similarity metrics between the users.

10. The computer-implemented method of claim 1, further comprising:
performing pro-actively nurturing a relationship based on triggering events including at least one of ratings, communication history between the users, location of the users, idle time of the relationship and any contextual information, to suggest to a user to perform nurturing activities based on changes affecting the relationship between the users and provide tools and execute workflows to the user to support the nurturing activities.

11. A computer program product comprising a computer useable medium including a computer readable program, wherein the computer readable program when executed on a computer causes the computer to implement a method of automatically managing relationships between a plurality of users within an electronic social network, the method comprising:
monitoring interactions between the plurality of users in relationships within the electronic social network over time, and obtaining interaction information associated with the monitored interactions; and
automatically updating and managing access privileges of users based on the obtained interaction information, to access profile information of respective users.

12. The computer program product of claim 11, wherein the interaction information comprises at least one of duration of the relationship between the users and communication between the users.

13. The computer program product of claim 11, wherein automatically updating access privileges comprises automatically updating an amount and type of profile information accessibly to each user based on the monitored interaction information.

14. The computer program product of claim 13, wherein an amount of access privileges are varied based on the interaction information associated with the users such that as the interaction information increases, the amount of access privileges increases and as the interaction information decreases, the amount of access privileges decrease for a respective user.

15. The computer program product of claim 11, wherein the method further comprises automatically updating ratings on metrics corresponding to the users based on predetermined factors associated with the users, wherein the ratings on metrics are determined based on how a user is rated among other users in relationship with the same user within the electronic social network.

16. The computer program product of claim 15, wherein the ratings are
automatically updated based on at least one of communication between users, idle time of the relationship, contextual information, third-party information and similarity metrics between the users.

17. The computer program product of claim 11, the method further comprising:
performing pro-actively nurturing a relationship based on triggering events including at least one of ratings, communication history between the users, location of the users, idle time of the relationship and any contextual information, to suggest to a user to perform nurturing activities based on changes affecting the relationship between the users and provide tools and execute workflows to the user to support the nurturing activities.

18. An electronic social network system comprising:
a plurality of user interfaces;
a network; and
a server in communication with the plurality of user interfaces via the network, wherein the server is operative to:
monitor interactions between the plurality of users in relationships within the electronic social network system over time, and obtain interaction information associated with the monitored interactions, and
automatically update and manage access privileges of users based on the obtained interaction information, to access profile information of respective users.

19. The system of claim 18, wherein the interaction information comprises at least one of duration of the relationship between the users and communication between the users.

20. The system of claim 18, wherein an amount and type of profile information to be accessed to each user is automatically updated based on the monitored interaction information.

21. The system of claim 18, wherein an amount of access privileges are varied based the interaction information associated with the users such that as the interaction information increases, the amount of access privileges increases and as the interaction information decreases, the amount of access privileges decreases for a respective user.

22. The system of claim 19, wherein the server is further operative to automatically update ratings on metrics corresponding to the users based on predetermined factors associated with the users wherein the ratings on metrics are determined based on how a user is rated among other users in relationship with the same user within the electronic social network system.

23. The system of claim 22, wherein the ratings are automatically updated based on at least one of communication between users, idle time of the relationship, contextual information, third-party information and similarity metrics between the users.

24. The system of claim 23, wherein the server is further operative to perform pro-actively nurturing a relationship based on triggering events including at least one of ratings, communication history between the users, location of the users, idle time of the relationship and any contextual information, by suggesting to a user to perform nurturing activities based on changes affecting the relationship between the users and providing tools and executing workflows to the user to support the nurturing activities.
